(19) United States
(12) Patent Application Publication
(10) Pub. No.: US 2018/0104983 A1
(43) Pub. Date: Apr. 19, 2018

(54) THREE-WHEEL DRIVE FOR SPHERICAL SURFACES

(71) Applicant: George W. Batten, JR., Houston, TX (US)

(72) Inventor: George W. Batten, JR., Houston, TX (US)

(21) Appl. No.: 15/786,586

(22) Filed: Oct. 17, 2017

Related U.S. Application Data
(60) Provisional application No. 62/410,070, filed on Oct. 19, 2016.

(51) Int. Cl. B60B 19/00

(52) U.S. Cl. CPC B60B 19/003; B60B 19/14

(57) ABSTRACT

This invention uses three fixed-position omniwheels and their associated motors to drive any possible rotation of a sphere. The mechanism is much simpler than mechanisms using multidirectional wheels (i.e., conventional wheels with a mechanism which changes the orientation of their axes). The invention can be applied for rotating surfaces which are approximately, but not perfectly, spherical.

### CROSS-REFERENCE TO RELATED APPLICATIONS

### U.S. Patent Documents

This patent claims the benefit of U.S. Provisional Patent No. 62/410,070 filed on Oct. 19, 2016, which is herein incorporated by reference.

| | | | | |
|---|---|---|---|---|
| 7,980,336 | July 2011 | Takenaka, et al. | Omni-directional drive device and | 180/10 |
| | | | omni-directional vehicle using the | |
| | | | same | |
| 2010/0243,342 | September 2010 | Wu, et al. | Omni-wheel based drive mechan- | 180/7.1 |
| | | | ism | |

### REFERENCED DOCUMENTS

### U.S. Patent Documents

| | | | | |
|---|---|---|---|---|
| 1,305,535 | June 1919 | Grabowiecki | Vehicle wheel | |
| 5,490,784 | February 1996 | Carmein | Virtual reality system with en- | 434/55 |
| | | | hanced sensory apparatus | |
| 3,789,947 | February 1974 | Blumrich | Omnidirectional Wheel | 180/79.3 |
| 9,126,121 | August 2015 | Harris, et al. | Three-axis ride controlled by smart- | A63G 31/16 |
| | | | tablet app | |
| 9,427,649 | August 2016 | Teevens, et al. | Mobile device which simulates | A63B 69/345 |
| | | | player motion | |

### OTHER PUBLICATIONS

### Whittaker, E. T., ATreatise on the Analytical Dynamics of Particles and Rigid Bodies, 4th Ed., Cambridge, 1959

### Goldstein, G., Classical Mechanics, Cambridge (Addison-Wesley), 1950.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

An omniwheel comprises a disk, herin called the “base disk” or simply “disk,” on the periphery of which there is a plurality of small wheels, herein called “planetary wheels,” with rotational axes not aligned with the axis of the disk. A disk's rotational axis is the line through the center of the disk and orthogonal to the plane of the disk. For purposes of explanation, the periphery of the base disk will be taken as passing through the centers of the planetary wheels.

Commonly, the axes of the planetary wheels are orthogonal to the axis of the base disk (i.e., they are tangental to the periphery of the base disk). This kind of omniwheel was patented by Grabowiecki (U.S. Pat. No. 1,305,535) in 1919. Another omniwheel patent (Blumrich, U.S. Pat. No. 3,789,947) was issued in 1974. Examples in which the axes of the planetary wheels are not aligned orthogonally appear in a patent by Takenaka (U.S. Pat. No. 7,980,336).

When an omniwheel is pressed against a surface, the point of contace is on particular planetary wheel, and friction at that point restricts motion in the direction of the axis of the planetary wheel, but the rotary freedom of the planetary wheel allows free motion on the surface in the diretion ortogonal to the axis of the planetary wheel. Thus, for example, if the base disk is mounted so it is freewheeling, then there are no limits to the motion of the assembly on the surface. This was a main intent of the Grabowiecki patent. Alternately, if the base disk is rotatably driven, the rotation forces the assembly (or the surface) to move in the direction of the axis of the planetary wheel having the contact point. The latter is applied in this patent.

There are numerous methods using frictional drive for causing surfaces to move. Many of these are directed at moving spherical wheels for omnidirectional vehicle movement on a roadway or other surfaces. For this purpose, it is necessary to move the sphere in only two rotational directions, so the motion of the sphere can be described using the terms “pitch” and “roll” commonly applied to ships and aircraft; the third term “yaw” is not needed. Descriptions of some arrangements moving spherical wheels in this way appear in U.S. patent documents 7,980,336, 2010/0243,342, and 9,427,649.

For other applications, motion in three rotational directions, roll, pitch, and yaw, are needed. Examples are motion simulators for training pilots and astronauts; computer-controlled virtual reality systems; and motion-stabilized, sphere-mounted cameras (see, for example, Harris, U.S. Pat. No. 9,126,121).

Another example appears in U.S. Pat. No. 5,490,784, which describes a generally spherical capsule with three rotational degrees of freedom frictionally driven by multidirectional wheels. At least two such multidirectional wheels are required, and each of those is a complicated mechanical system having two electric motors. FIGS. 4, 5, and 6 of that patent illustrate the complexity of the drive mechanisms.

U.S. Pat. No. 9,126,121 presents an example of a computer-controlled virtual-reality system with a shell that is part of a sphere supported and driven by multidimensional rollers. It, also, requires two mechanically-complicated multidirectional wheels with two electric motors each.

All such systems which use two or more drive wheels must be arranged to avoid wheel binding which occurs if sphere motion due to one drive wheel is different from that due to another drive wheel. One way to do this is to have all drive wheels oriented for the same sphere motion. This is implied in U.S. Pat. Nos. 5,490,784 and 9,126,121 just mentioned. Another way is to use drive wheels for which friction in the driven direction is high, but that in the perpendicular direction is very low, as can be done with omniwheels. This method is used in U.S. patent documents 7,980,336, 2010/0243,342, and 9,427,649 mentioned earlier.

### BRIEF SUMMARY OF THE INVENTION

This invention provides a simpler mechanism for moving surfaces in three rotational directions. Specifically, it uses three driven omniwheels with mutually orthogonal axes to frictionally drive a surface in any rotational direction. The omniwheels are fixed in position, so complicated mechanical arrangements for changing their axes of rotation are not needed. If only two rotational directions are needed, two driven omniwheels and a freely rotating omniwheel (or other omnidirectional support, such as an omnidirectional bearing) can be used, but that is already commonly done, as in some of the patents already mentioned, so it is not intended as part of this invention. Three-direction rotational motion needs three omniwheels driven by three independent motors. This is fewer than the four or more motors needed by other arrangements.

Driving spherical surfaces by the use of three omniwheels with mutually orthogonal axes does not seem to have been noticed previously.

### BRIEF DESCRIPTION OF THE SEVERAL VIEWS OF THE DRAWINGS

FIG. 1 is a schematic illustration of a sphere S driven in any rotation by three omniwheels. Part of the front surface is broken out to show the third wheel and great-circle wheel paths passing along the rear surface. Omniwheel positions are indicated by ellipses indicating the outer-edge paths of the planetary wheels.

FIG. 2 is an enlargement of part of FIG. 1 with an added path 8 showing that a motion produced by one wheel 3 crosses another wheel 2, thereby causing wheel binding if wheel 2 is a conventional wheel rather than an omniwheel, or if the great circles corresponding to the wheels are not orthogonal.

FIG. 3 is a schematic illustration of a sphere S similar to FIG. 1 except that the wheel orientations have been changed so that the associated great circles are mutually orthogonal.

### DETAILED DESCRIPTION OF THE INVENTION

According to Euler's theorem on rotations about a point (see Whittaker, p.3; Goldstein, p. 118), any rotation of a rigid body about a fixed point can be represented by a single vector, the length of which is proportional to the angle of rotation. Furthermore, simple vector calculations show that if a rigid body undergoes a sequence of such rotations, the result is a rotation for which the vector is the algebraic sum of the vectors of the rotations in the sequence. This also applies if the actions to create the rotations in the sequence are applied simultaneously and continuously.

Consider a surface S such as the surface of a sphere. Let V₁, V₂, and V₃ be the rotation vectors of wheels frictionally driving the motion of S. Then, assuming the motions of the wheels do not mutually interfere (i. e., there is no wheel binding), the resultant vector of rotation of the sphere S is V=−(V₁+V₂+V₃), the minus sign being necessary because each wheel drives a sphere rotation opposite to its own.

Let U₁, U₂, and U₃ be unit vectors in the axial directions of the the wheels, so that the rotation vectors are V₁=α₁U₁, V₂=α₂U₂, and V₃=α₃U₃, where α₁, α₂, and α₃ are the respective angles of rotations of the wheels (which angles can be negative, of course). If the vectors U₁, U₂, and U₃ are linearly independent, then any rotation vector V is a linear combination of those vectors, so any desired rotation V of the surface can be obtained by choosing the angles of rotation of the wheels so that V=—(α₁U₁+α₂U₂+α₃U₃).

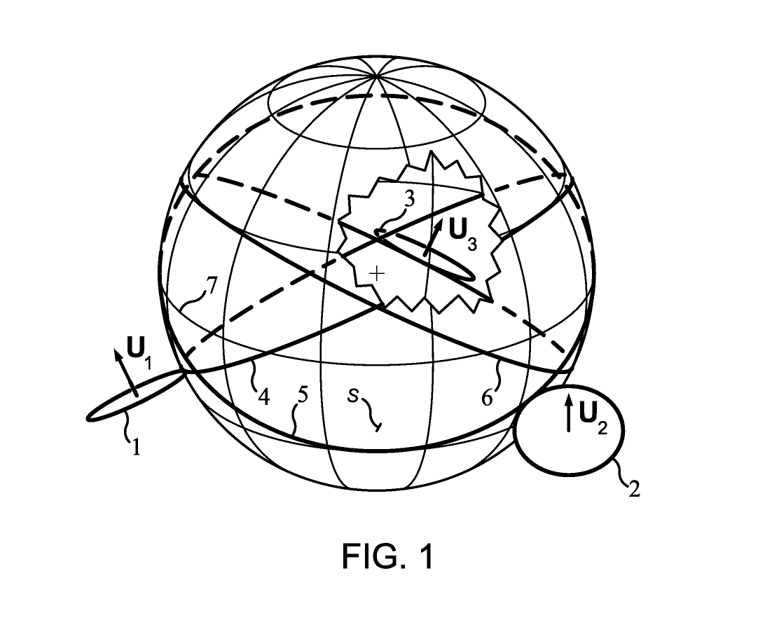

FIG. 1 schematically illustrates concepts related to the instant invention. Sphere S is supported on three omniwheels 1, 2, and 3, which are fixed in position so their axial vectors U₁, U₂, and U₃, respectively, are fixed in space but are not coplaner (so they are linearly independent). The rotational axis of each planetary wheel is orthogonal to the rotational axis of its base disk. For simplicity, in the following description each omniwheel is treated as a circular disk lying in a plane passing through the center of the sphere S. A breakout in the front surface of S reveals omniwheel 3 contacting the rear surface of S, that surface being treated as transparent for purposes of illustration. The sphere is shown with lines of latitude and longitude (with equator 7) which move with the sphere.

If there is no friction at omniwheels 1 and 3, as omniwheel 2 rotates it frictionally turns sphere S, and the sphere's point of contact moves on great circle 5. The same applies mutatis mutandis for omniwheels 1 and 3 and their respective great circles 4 and 6. The great circle corresponding to one of the omniwheels will be referred to as the “great circle of motion” for that omniwheel. The three great circles of motion are fixed in space relative to the positions of the omniwheels: they do not move as the sphere rotates.

In FIG. 1 the omniwheels are positioned so that the great circles touch the latitude lines 30 degrees on each side of equator 7.

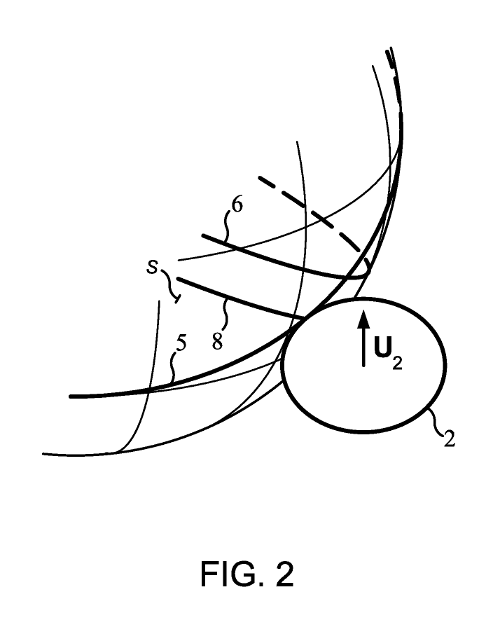

FIG. 2 shows what happens near omniwheel 2. Assuming that there is no friction at omniwheels 1 and 2, as omniwheel 3 turns it causes points on the line 8 parallel to great circle of motion 6 to move at an angle across wheel 2. At the point of contact of the omniwheel with the sphere, the motion can be resolved into two components, one tangent to the great circle of motion 5 and the other orthogonal to that one, with both components lying in the sphere's tangent plane at the point of contact. Now considering that there is friction at omniwheel 2, since the rotational axis of that sphere-contacting planetary wheel is tangent to great circle of motion 5, it offers zero (or very little) frictional resistance to the component orthogonal to the great circle of motion. That is not the case for the other component, for there must be considerable friction in that direction in order that the wheel drive the sphere. This is still the case if there is friction at all omniwheels and the omniwheels rotate. Therefore, the arrangement of FIGS. 1 and 2 has a large amount of wheel binding.

It is apparent from FIG. 2 that there will always be binding if conventional wheels are used.

On the other hand, omniwheels will have the desired effect of isolating the actions of each wheel from those of the other wheels if the great circles are orthogonal to each other. This is the same as saying that the omniwheel vectors U₁, U₂, and U₃ are to be mutually orthogonal.

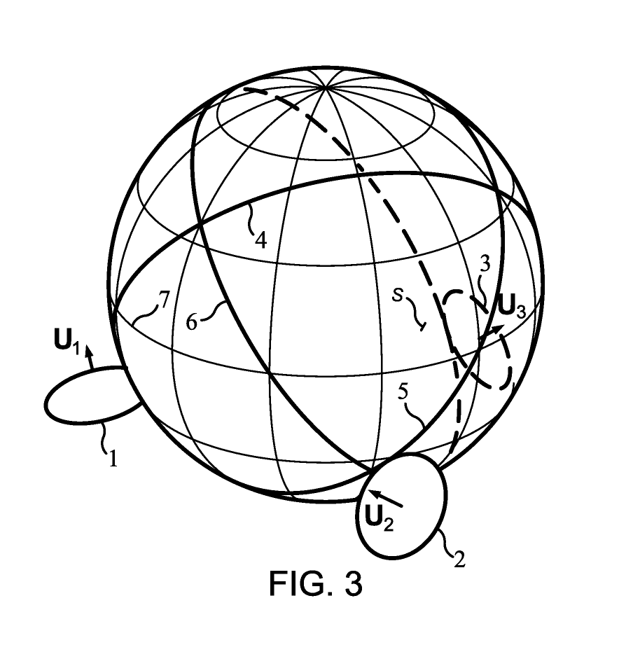

Such an arrangement is possible. Indeed, for such an arrangement, the angle φ between the normal vector of each great circle and a fixed central vector will satisfy cosφ=1/\sqrt{3}(soφ≈54.7° . FIG. 3 illustrates this. In that figure the omniwheel axes (and therefore the great circles of motion) are orthogonal. Except for great circle 6. the parts of the great circles on the back side of the sphere have been omitted for clarity.

The contact point of the driving omniwheel of a great circle of motion can be placed anywhere on the great circle of motion if the plane of the omniwheel coincides with the plane of the great circle. It is easy to see that there can be more than one omniwheel on a great circle.

It is not necessary that the arrangement of the driving omniwheels be symmetrical, and this provides some flexibility in designing a mechanism of this invention. However, since the great circles must be orthogonal to each other, there can be only three of them.

The description given above relates to omniwheels for which the axes of the planetary wheels lie in the plane of the corresponding base disk. As has already been mentioned, omniwheels with planetary-wheel axes not paallel to the plane of the base disk are known. Using such an omniwheel changes the angle between the axis of the omniwheel and that of the associated great circle; the tangent to the great circle is parallel to the rotational axis of the planetary wheel at the point of contact. This can be used to change the mechanical configuration (e.g., arrange the axes of the omniwheels to be parallel), but it does not eliminate the need for orthogonality of the great circles.

It is apparent that the invention can be applied to surfaces which are not complete spheres provided the rotation of the omniwheels is sufficiently restricted.

Persons knowledgeable of the appropriate art will see that the invention can be used to drive motions of surfaces that are approximately, but not perfectly, spherical. For such surfaces it is, in general, not possible to make the lines of motion (corresponding to great circles on spherical surfaces) orthogonal at every point, so there will be some frictional losses.

This description has focused on arrangements with omniwheel axes fixed in space, but it applies to any arrangement for which the relative positions of the driven great circles are fixed; i.e., for which the driven great circles are mutually orthogonal. Thus, for example, the invention could be used for a vehicle supported by a single spherical wheel, the omniwheels being mounted on the supported chassis.

1. A mechanism frictionally moving a spherical surface, said mechanism comprising three rotationally-driven omniwheels;
the said omniwheels mounted in mutually fixed positions;
the rotational axes of the planetary wheels of each omniwheel being orthogonal to the rotational axis of the omniwheel;
each omniwheel touching the spherical surface at a point on one of the planetary wheels of said omniwheel, thereby providing the friction necessary to drive the motion of the spherical surface; with
the three great circles of motion driven by the three omniwheels mutually orthogonal.

2. A mechanism as in claim 1 for which the three omniwheels are replaced by three sets of omniwheels,
each set of omniwheels having one or more rotationally-driven omniwheels; with
the great circle of motion for each omniwheel coinciding with the great circles of motion for all other omniwheels in its set; and
the three great circles of motion for the three sets mutually orthogonal.

3. A mechanism as in claim 1 for which the axes of one or more omniwheels are not orthogonal to the axis of the corresponding omniwheel.

4. A mechanism as in claim 1 for which the driven surface is not a complete sphere.

5. A mechanism as in claim 1 for which the driven surface is approximately, but not perfectly, spherical.
